(19) United States
(12) Patent Application Publication
(10) Pub. No.: US 2011/0072049 A1
(43) Pub. Date: Mar. 24, 2011

(54) Dynamic Process Management System for Processing Data in Various Environments

(75) Inventors: Sang Yeol Park, Cheju-City (KR); Sang Hyon Oh, Seoul (KR)

(73) Assignee: JAVA INFORMATION TECHNOLOGY LTD., Cheju-City (KR)

(21) Appl. No.: 12/563,225

(22) Filed: Sep. 21, 2009

(51) Int. Cl. G06F 7/00

(52) U.S. Cl. 707/792; 707/E17.044

(57) ABSTRACT

The present invention relates to a dynamic process management system for processing data in various environments. The dynamic process management system includes an interface unit for receiving a specific command from a user, a process-based management unit for mapping relevant processes to memory using information about the processes in compliance with the command received through the interface unit, and a code-based unit for storing classes related to the process information. Accordingly, the present invention is advantageous in that only the data desired by the user can be acquired using user-defined processes.

### BACKGROUND OF THE INVENTION

1. Field of the Invention

The present invention relates, in general, to a dynamic process management system for processing data in various environments, and, more particularly, to a dynamic process management system which transmits the meaning information of real-time data to a user by mapping processes defined by the user to memory.

2. Description of the Related Art

Various types of software technology have been developed to process large-capacity data. In 1970, operations were performed using large mainframe computers to process large-capacity data. However, recently, the environment in which a sufficiently large amount of data can be processed even using small computers has been provided.

Generally, database (DB) technology has been developed as a technology for storing and processing large-capacity data. In particular, a relational DB for storing relationships between attributes and an object-based DB for adding methods of processing data to the relational DB have been most widely commercialized.

However, recently, DB technology has limitations in processing the large amounts of data that have been steadily input over wireless and wired networks following the development of wired/wireless network technology. A representative example for processing data in such an environment is STREAM developed at Stanford. In STREAM, data input from various sources is contracted and stored in real time, and a user acquires information using a query language similar to a Structured Query Language (SQL). However, even if a large amount of data is contracted and stored, two problems may arise. First, with the passage of time, an available data storage space that may be accommodated in a single computer is insufficient. Second, it is difficult to determine whether the contracted and stored data has any meaning.

### SUMMARY OF THE INVENTION

Accordingly, the present invention has been made keeping in mind the above problems occurring in the prior art, and an object of the present invention is to provide a dynamic process management system for processing data in various environments, which can acquire only the data desired by a user using user-defined processes based on process management rather than using a scheme for storing a large amount of data to process the data.

In order to accomplish the above object, the present invention provides a dynamic process management system for processing data in various environments, comprising an interface unit for receiving a specific command from a user, a process-based management unit for mapping relevant processes to memory using information about the processes in compliance with the command received through the interface unit, and a code-based unit for storing classes related to the process information.

Preferably, the process-based management unit comprises a request manager unit for analyzing the command received through the interface unit, a class manager unit for determining which class is inherited by the processes defined in the command analyzed by the request manager unit, a class loader unit for reading the class determined by the class manager unit from the code-based unit and loading the class into the memory, and a process manager unit for generating objects from classes based on a topology defined in the command analyzed by the request manager unit, and mapping the objects to the memory in an order of processes present in the topology.

Preferably, the analysis of the received command is performed by determining whether the command is a command issued by a properly authorized user.

Preferably, the dynamic process management system further comprises an authorized user information storage unit for storing information about the authorized user, wherein the request manager unit analyzes the command using information stored in the authorized user information storage unit.

Preferably, the analysis of the received command comprises analysis of a specification indicating relationships among a plurality of processes.

Preferably, the specification is one of a linear topology, a join topology, a distributed topology, a hub topology, a recursive topology and a feedback topology.

Preferably, each of the processes defined in the analyzed command comprises a primitive object.

Preferably, each of the processes defined in the analyzed command comprises a listener for receiving data, a processor for processing the data, and a reporter for transmitting resulting data.

Preferably, after mapping to the memory has been terminated, results of processing are transmitted to a Uniform resource Locator (URL) defined by the specification.

### BRIEF DESCRIPTION OF THE DRAWINGS

FIG. 1 is a diagram showing the construction of a dynamic process management system for processing data in various environments according to the present invention;

FIG. 2 is a diagram showing a process-based management unit in detail;

FIG. 3 is a diagram showing a first embodiment of defined specification;

FIG. 4 is a diagram showing a second embodiment of the defined specification;

FIG. 5 is a diagram showing a third embodiment of the defined specification;

FIG. 6 is a diagram showing a fourth embodiment of the defined specification;

FIG. 7 is a diagram showing a fifth embodiment of the defined specification;

FIG. 8 is a diagram showing a sixth embodiment of the defined specification; and

FIG. 9 is a diagram showing the structure of a process schema.

### DESCRIPTION OF THE PREFERRED EMBODIMENTS

The above and other objects, features and advantages of the present invention will be more clearly understood from the following detailed description taken in conjunction with the accompanying drawings. Hereinafter, embodiments of the present invention will be described in detail to allow those skilled in the art to easily understand and implement the present invention with reference to the attached drawings.

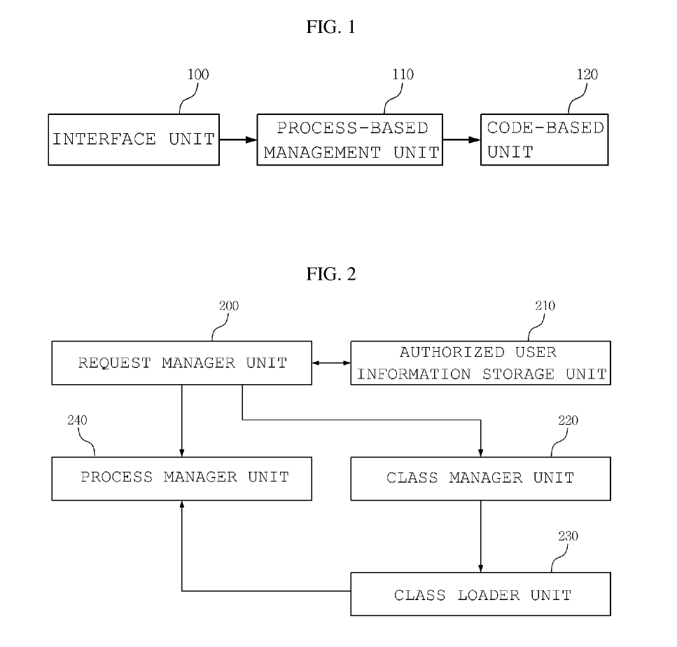

FIG. 1 is a diagram showing the construction of a dynamic process management system for processing data in various environments according to the present invention. As shown in the drawing, a dynamic process management system for processing data in various environments includes an interface unit 100, a process-based management unit 110, and a code-based unit 120.

The interface unit 100 receives a specific command from a user. The interface unit 100 receives a command, which allows the dynamic process management system for processing data in various environments to perform a specific operation, from the user located outside the system.

The process-based management unit 110 maps relevant processes to memory in compliance with the command, received through the interface unit 100, using information about the processes. FIG. 2 is a diagram showing the process-based management unit in detail. As shown in the drawing, the process-based management unit includes a request manager unit 200, an authorized user information storage unit 210, a class manager unit 220, a class loader unit 230, and a process manager unit 240.

The request manager unit 200 analyzes the command received through the interface unit 100. The request manager unit 200 determines whether the command received through the interface unit 100 is a command issued by a properly authorized user. The request manager unit 200 receives identification (ID) or a specific access number, required to identify that the user is a properly authorized user, through the interface unit 100 so as to determine whether the received command is a command issued by the properly authorized user, thus performing such determination. However, methods of determining whether the user is a properly authorized user are not limited to the above method, and may also be performed by receiving any information required to identify the features of a user who accesses the system and by identifying the user as an authorized user.

Further, the request manager unit 200 analyzes the contents of the command. The command received through the interface unit 100 defines a specification indicating the relationships among a plurality of processes.

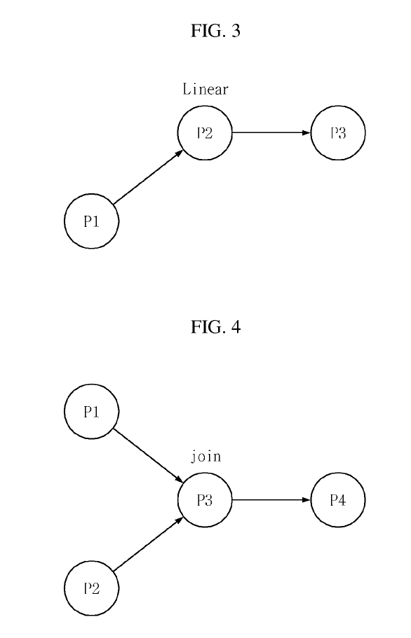

FIG. 3 is a diagram showing a first embodiment of the defined specification. As shown in the drawing, the specification defined in the command received through the interface unit is a linear topology. A linear topology is a structure in which two or more processes are connected in one direction. Such a topology is the most basic structure, which is used in most middleware systems. That is, a linear topology receives one input, processes the input and generates one output. The drawing illustrates a connection relationship obtained when processes P1, P2 and P3 are present. When such a connection relationship is represented in a Process Management Language (PML), {P1->P2, P2->P3} is obtained.

FIG. 4 is a diagram showing a second embodiment of the defined specification. As shown in the drawing, the specification defined in the command received through the interface unit is a join topology. A join topology is a structure for receiving two or more inputs, processing the inputs and generating one output. This topology is used when two or more inputs have meanings. The drawing illustrates a connection relationship obtained when processes P1, P2, P3 and P4 are present. When this connection relationship is represented in a PML, {P1->P3, P2->P3, P3->P4} is obtained.

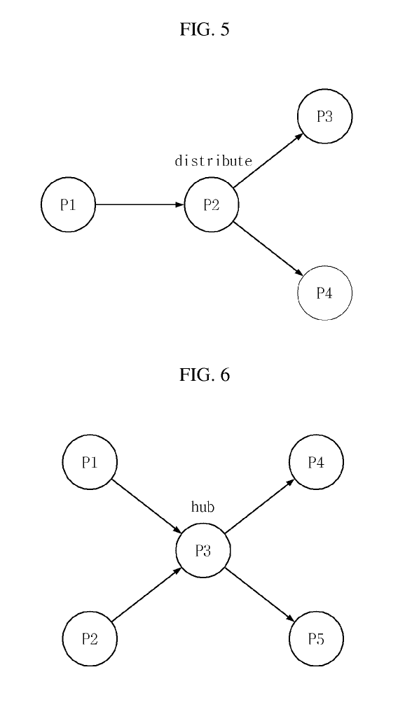

FIG. 5 is a diagram showing a third embodiment of the defined specification. As shown in the drawing, the specification defined in the command received through the interface unit is a distributed topology. A distributed topology is a structure for receiving one input, processing the input, and transmitting a resulting output to two or more different processes. Processes to which the output is to be transmitted according to the input information may be additionally set when the processes are designed. The drawing illustrates a connection relationship obtained when processes P1, P2, P3 and P4 are present. When this connection relationship is represented in a PML, {P1->P2, P2->P3, P2->P4} is obtained.

FIG. 6 is a diagram showing a fourth embodiment of the defined specification. As shown in the drawing, the specification defined in the command received through the interface unit is a hub topology. A hub topology is a structure for receiving two or more inputs, processing the inputs, and transmitting resulting information to two or more processes. Similarly to that of the join topology, the parts of the received information which are related to each other are combined with each other, and such piece of combined information is transmitted to various different processes according to the condition thereof. The drawing illustrates a connection relationship obtained when processes P1, P2, P3, P4 and P5 are present. When this connection relationship is represented in a PML, {P1->P3, P2->P3, P3->P4, P3->P5} is obtained.

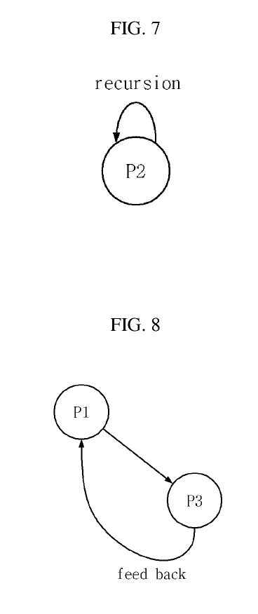

FIG. 7 is a diagram showing a fifth embodiment of the defined specification. As shown in the drawing, the specification defined in the command received through the interface unit is a recursive topology. A recursive topology is obtained by applying the linear topology and is configured such that the output of one process is returned to the process itself as the input thereof. Such a recursive topology is used when a repetitive operation on specific information is required. The drawing illustrates a connection relationship obtained when a process P2 is present. When such a connection relationship is represented in a PML, {P2->P2} is obtained.

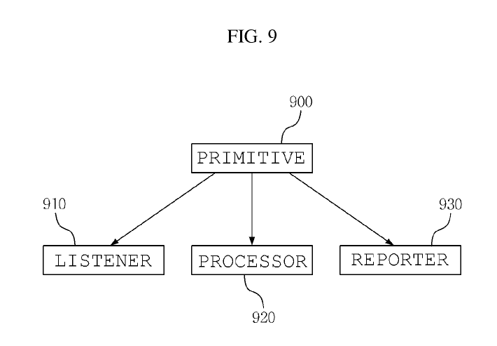

FIG. 8 is a diagram showing a sixth embodiment of the defined specification. As shown in the drawing, the specification defined in the command received through the interface unit is a feedback topology. A feedback topology is obtained by applying the linear topology and is configured such that the output of one process is fed back to another previous process as the input thereof. The feedback topology is used when a repetitive operation on specific information is required. The drawing illustrates a connection relationship obtained when processes P1 and P3 are present. When this connection relationship is represented in a PML, {P1->P3, P3->P1} is obtained.

Meanwhile, the authorized user information storage unit 210 stores information about an authorized user. The authorized user information storage unit 210 stores information required when the request manager unit 200 determines whether an accessing user is a properly authorized user. The authorized user information storage unit 210 transmits the stored information at the request of the request manager unit 200.

The class manager unit 220 determines which class is inherited by the processes defined in the command which was analyzed by the request manager unit 200. The structure of each process defined in the command is defined as a process schema. FIG. 9 is a diagram showing the structure of a process schema. As shown in the drawing, in the process schema, a primitive object 900 located in the highest level is inherited by all classes, and is defined by a manager as the basic name of the system. The lower classes of the primitive object, that is, a listener 910, a processor 920 and a reporter 930, are the most basic classes of the system. The respective classes perform their own functions for receiving, processing and transmitting data, and classes to be used by each of users may be generated by inheritance from the above classes. Each of the classes to be used by each user has only a data definition part and a method declaration part. Therefore, in practice, typical users inherit interfaces, and define methods using the data definition part on the basis of application by the users.

The class loader unit 230 loads the class determined by the class manager unit 220 into the memory. In detail, the class loader unit 230 reads the class determined by the class manager unit 220 from the code-based unit 120, and loaded the class into the memory.

The process manager unit 240 generates objects from classes on the basis of the topology defined in the command which was analyzed by the request manager unit 200, and sequentially maps the objects to the memory in the order of the processes present in the topology. After the mapping to the memory has been terminated, the results of processing are transmitted to a Uniform Resource Locator (URL) defined by the specification.

The code-based unit 120 stores a plurality of classes. The code-based unit 120 stores classes newly defined by the process schema. A specific one of the plurality of stored classes is read by the class loader unit 230.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the above embodiments should be considered from a descriptive standpoint rather than a restrictive standpoint. The scope of the present invention is defined by the accompanying claims rather than by the above description, and all differences falling within the equivalent scope thereof should be interpreted as being included in the present invention.

According to the present invention, there is an advantage in that only the data desired by a user can be acquired using user-defined processes.

What is claimed is:

1. A dynamic process management system for processing data in various environments, comprising:
an interface unit for receiving a specific command from a user;
a process-based management unit for mapping relevant processes to memory using information about the processes in compliance with the command received through the interface unit; and
a code-based unit for storing classes related to the process information.

2. The dynamic process management system according to claim 1, wherein the process-based management unit comprises:
a request manager unit for analyzing the command received through the interface unit;
a class manager unit for determining which class is inherited by the processes defined in the command analyzed by the request manager unit;
a class loader unit for reading the class determined by the class manager unit from the code-based unit and loading the class into the memory; and
a process manager unit for generating objects from classes based on a topology defined in the command analyzed by the request manager unit, and mapping the objects to the memory in an order of processes present in the topology.

3. The dynamic process management system according to claim 2, wherein the analysis of the received command is performed by determining whether the command is a command issued by a properly authorized user.

4. The dynamic process management system according to claim 3, further comprising an authorized user information storage unit for storing information about the authorized user,
wherein the request manager unit analyzes the command using information stored in the authorized user information storage unit.

5. The dynamic process management system according to claim 3, wherein the analysis of the received command comprises analysis of a specification indicating relationships among a plurality of processes.

6. The dynamic process management system according to claim 5, wherein the specification is one of a linear topology, a join topology, a distributed topology, a hub topology, a recursive topology and a feedback topology.

7. The dynamic process management system according to claim 5, wherein each of the processes defined in the analyzed command comprises a primitive object.

8. The dynamic process management system according to claim 7, wherein each of the processes defined in the analyzed command comprises:
a listener for receiving data;
a processor for processing the data; and
a reporter for transmitting resulting data.

9. The dynamic process management system according to claim 5, wherein, after mapping to the memory has been terminated, results of processing are transmitted to a Uniform resource Locator (URL) defined by the specification.
